(19) United States
(12) Patent Application Publication
(10) Pub. No.: US 2007/0106185 A1
(43) Pub. Date: May 10, 2007

(54) Portable body massager

(76) Inventors: Roman Ferber, West Bloomfield, MI (US); Stephen Chung, Taipei (TW)

Correspondence Address: BROOKS KUSHMAN P.C., 1000 TOWN CENTER, TWENTY-SECOND FLOOR, SOUTHFIELD, MI, 48075, US

(21) Appl. No.: 11/589,442

(22) Filed: Oct. 30, 2006

Related U.S. Application Data
(63) Continuation-in-part of application No. 10/836,905, filed on Apr. 30, 2004, now Pat. No. 7,128,721.

(51) Int. Cl. A61H 15/00

(52) U.S. Cl. 601/86; 601/87; 601/98; 601/101; 601/103; 601/112

(57) ABSTRACT

The present invention discloses a body massager comprising a portable housing including a backrest and a seat support. A longitudinal guide is provided in the backrest cooperating with a carriage for translation of the carriage within the backrest and a motor drives the carriage along the guide. A pair of massage members are supported by the carriage and extend from the backrest for imparting a massage effect upon the back of the user. The seat support includes a massager therein for imparting another massage effect to the user.

### CROSS-REFERENCE TO RELATED APPLICATIONS

This application is a continuation-in-part of U.S. application Ser. No. 10/836,905; filed Apr. 30, 2004, now U.S. Pat. No. 7,128,721.

### BACKGROUND OF THE INVENTION

1. Field of the Invention

The present invention relates to massagers, particularly to portable body massagers.

2. Background Art

The prior art includes body massagers provided within chairs, as well as in portable cushions. These prior art body massagers commonly include a track or guide for moving a massage assembly longitudinally within the chair or cushion. The prior art body massagers are relatively complex and utilize many components, thereby requiring sufficient structure to support the massager and limiting the portability of the massager. Due to the complexities of conventional body massagers, a consumer's ability to procure such massagers is limited due to value and affordability.

For example, many prior art body massagers include a complex guide system and frame thereby requiring a housing that is sufficiently robust, such as a chair. Many prior art body massagers require two motors, one for translating the massage mechanism, and the other for imparting the massage effect from the massage mechanism. Accordingly, these drawbacks of the prior art add both cost and weight to the prior art body massagers.

A goal of the present invention is to provide a simplified body massager having improvements in massage function, portability and cost in view of the prior art.

### BRIEF DESCRIPTION OF THE DRAWINGS

FIG. 1 is a perspective view of a first embodiment body massager in accordance with the present invention;

FIG. 2 is an exploded perspective view of a backrest region of the body massager of FIG. 1;

FIG. 3 is a front side elevation view of the backrest region of the body massager of FIG. 1, illustrated with a portion of a housing thereof partially removed;

FIG. 4 is an enlarged, front side elevation view of a carriage of the body massager of FIG. 1, illustrated within the backrest housing of the body massager with a cover plate removed therefrom;

FIG. 5 is an exploded perspective view of a seat support region of the body massager of FIG. 1;

FIG. 6 is a front side elevation view of a backrest region of another embodiment body massager in accordance with the present invention;

FIG. 7 is a front side elevation view of the backrest region of the body massager of FIG. 6, illustrated with a portion of a housing thereof partially removed;

FIG. 8 is an enlarged, front side elevation view of a carriage of the body massager of FIG. 6, illustrated within the backrest housing of the body massager;

FIG. 9 is another enlarged, front side elevation view of the carriage of the body massager of FIG. 6, illustrated within the backrest housing of the body massager with a cover plate removed therefrom;

FIG. 10 is yet another enlarged, front side elevation view of the carriage of the body massager of FIG. 6, illustrated within the backrest housing of the body massager, partially disassembled for depicting a portion of a transmission of the carriage; and

FIG. 11 is another enlarged, front side elevation view of the carriage of the body massager of FIG. 6, illustrated within the backrest housing of the body massager, partially disassembled for depicting another portion of the transmission.

### DESCRIPTION OF EMBODIMENTS OF THE INVENTION

As required, detailed embodiments of the present invention are disclosed herein; however, it is to be understood that the disclosed embodiments are merely exemplary of the invention that may be embodied in various and alternative forms. The figures are not necessarily to scale, and some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

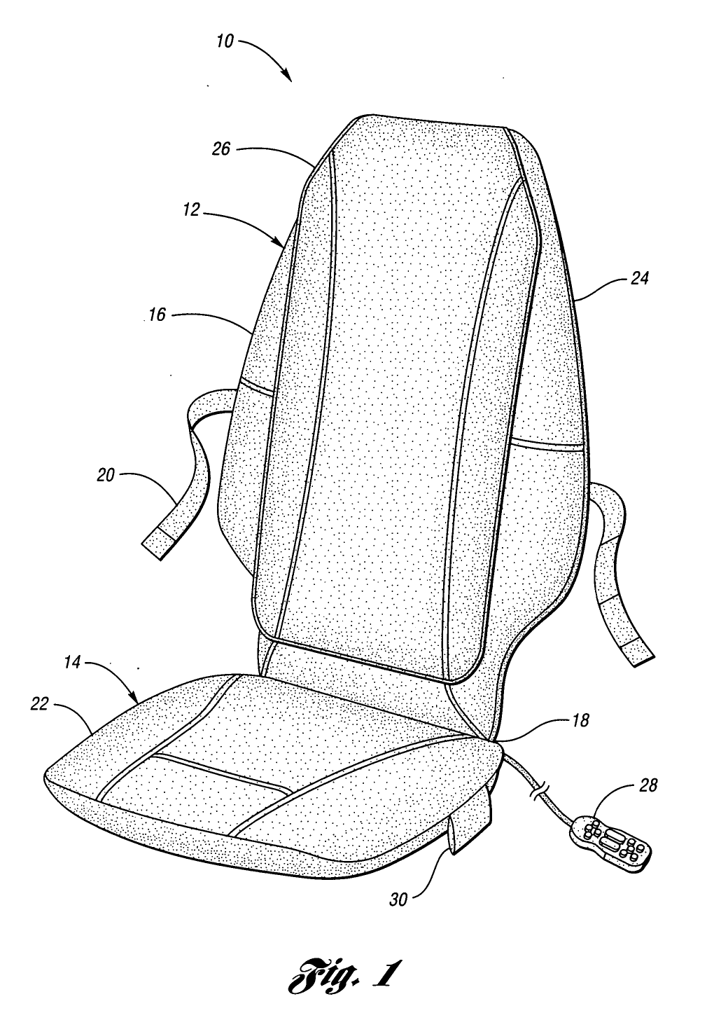

With reference to FIG. 1, a first embodiment body massager is illustrated in accordance with the present invention and is referenced generally by numeral 10. The body massager 10 includes a backrest region 12 and a seat support region 14. The internal assemblies of the backrest region 12 and the seat support region 14 are collectively retained within a flexible cover 16, which is formed of a high quality vinyl. Of course other materials such as leather may be employed for the cover 16. The cover 16 provides a pivotal connection 18 at a lower longitudinal end of the backrest region 12 and a rearmost end of the seat support region 14. The flexible material of the cover 16 provides a living hinge at the pivotal connection 18 permitting user adjustment of an included angle between the backrest region 12 and the seat support region 14.

Massage effects provided by the body massager 10 include a kneading massage effect provided in the backrest support 12, which is operable to provide the kneading massage effect longitudinally along the length of the backrest region 12. The seat support region 14 provides a vibratory massage effect to the user seated thereupon.

The backrest region 12 is sized to be received upon a backrest of a conventional chair. Likewise, the seat support region 14 is sized to be received upon a seat support of a conventional chair. Additionally, the body massager 10 is portable due to its compact size and light weight so that the user may place the body massager 10 upon a conventional chair for receiving a massage when seated upon the chair. The adjustability of the included angle between the backrest region 12 and the seat support region 14 accommodates a wide range of angles that may be incorporated in conventional chairs.

The backrest region 12 includes a height and width corresponding to the conventional chair and has a thickness that is adequate for housing the massage assembly therein while avoiding disruption of comfort and support provided by the underlying chair. Likewise, the seat support region 14 has a width and a depth corresponding to that of the conventional seat support and has a thickness that is adequate for housing the associated massage assembly while avoiding disruption of comfort and support provided by the underlying chair. Additionally, the backrest region 12 includes a pair of straps 20 mounted from its lateral sides for securing the body massager 10 to the conventional chair. The straps 20 each include one of a hook and loop material for securing the straps 20 about the backrest of the conventional chair. Of course, any engagement mechanism is contemplated, such as a belt buckle, a clip or the like.

By way of example, the backrest region 12 has a height of approximately twenty-five inches, an overall width of approximately eighteen inches, and a thickness of approximately two and a half inches. Also, by way of example, the seat support region 14 has a width of approximately sixteen and a half inches, a depth of approximately fourteen and a half inches, and a thickness of approximately one and three quarter inches. Of course, the invention contemplates that the body massager may have dimensions adequate to be received by any conventional chair. However, the dimensions of the first embodiment are suitable for most conventional chairs.

The seat support region 14 includes a seating surface 22 provided thereon for receiving the user when seated. The backrest region 12 includes a backrest surface 24 for receiving and supporting the back of the user thereupon. The massage assemblies of the backrest region 12 and the seat support region 14 impart the respective massage effects through the backrest surface 24 and seating surface 22 respectively. The cover 16 includes a removable flap 26 mounted to the backrest region 12 along the backrest surface 24. The flap 26 is removably attached by hook and loop material so that the user may remove the flap 26 and expose a woven fabric (not shown). The flexible material of the flap 26 includes dampening characteristics which reduce the massage effect imparted to the backrest surface 24. Accordingly, the user may remove the flap 26 to increase the massage intensity.

The body massager further includes a remote 28 connected thereto for controlling the operations of the massager 10. The cover 16 has a pocket 30 mounted to a lateral side of the seat support region 14. The pocket 30 has an opening provided in its rearward end so that the remote 28 may be conveniently retained when not in use.

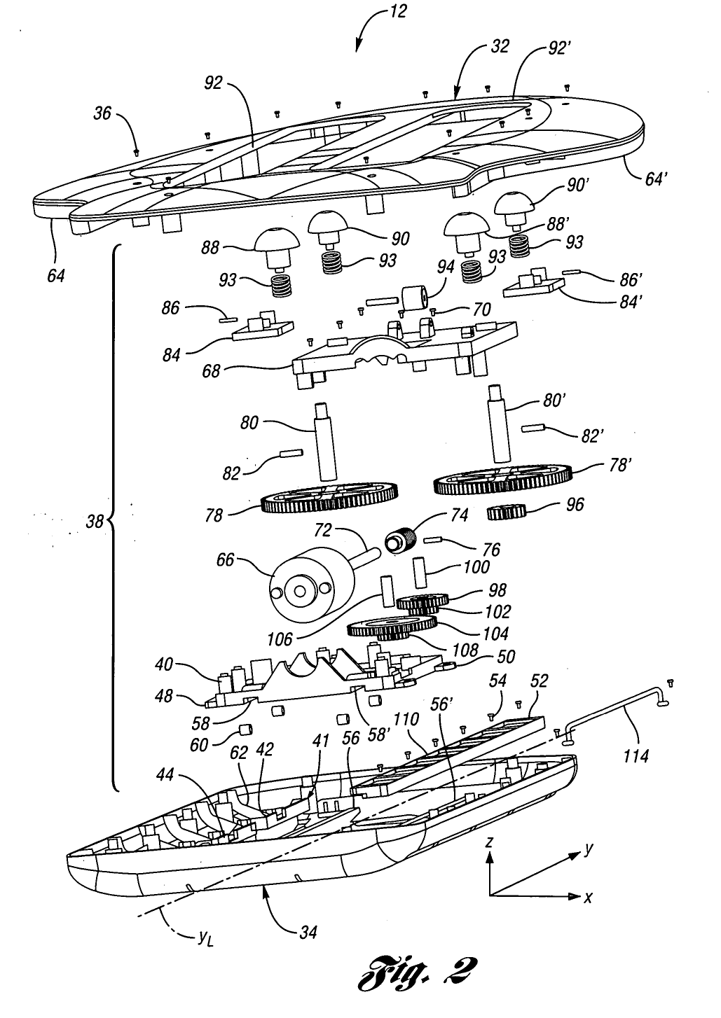

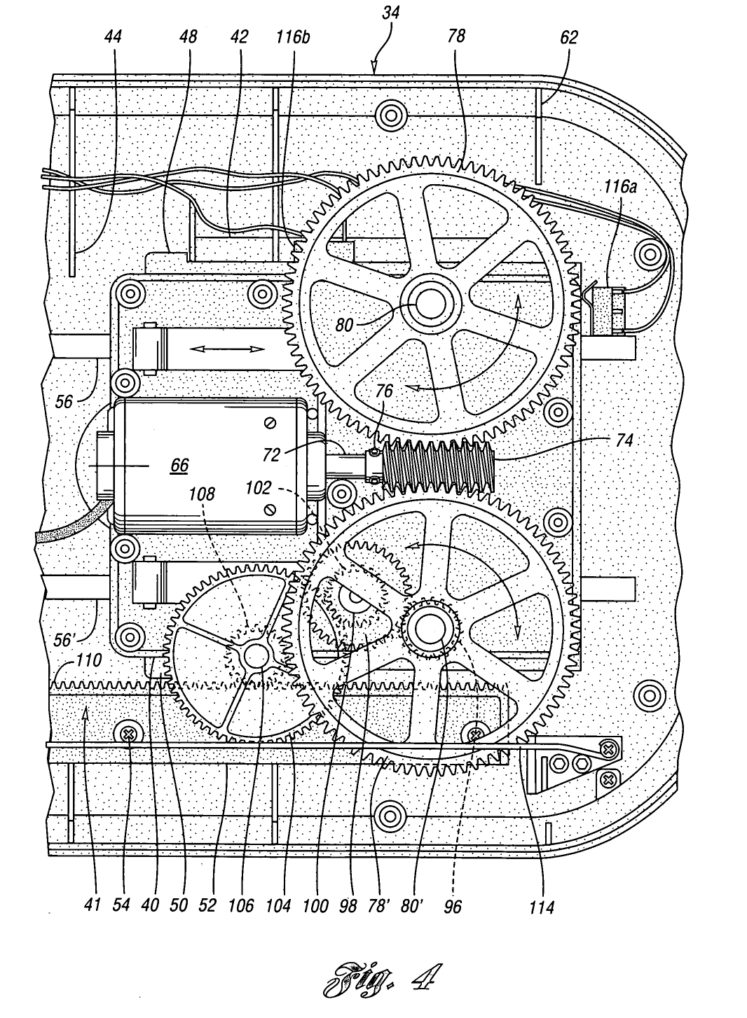

With reference now to FIGS. 2-4, the backrest region 12 is illustrated in greater detail. The backrest region 12 includes a two piece housing provided by an upper housing portion 32 and a lower housing portion 34. The upper housing portion 32 and the lower housing portion 34 are sized and adaptable to be secured together by a plurality of fasteners 36 for retaining components of a massage assembly 38 therein. The massage assembly 38 includes a carriage 40 which cooperates with the lower housing portion 34 for limited longitudinal translation within the backrest region 12. Accordingly, the lower housing portion 34 includes a longitudinal guide 41 mounted therein for cooperating with the carriage 40. The longitudinal direction y is illustrated in FIG. 2 and the housing includes a longitudinal axis y_{L}. The guide 41 includes a series of gibs indicated and referenced as upper gib 42, central gib 44 and lower gib 46. The gibs, 42, 44, 46 of the lower housing portion 34 cooperate with and retain a first longitudinal key 48 formed laterally along the carriage 40. The carriage 40 includes a second longitudinal key 50 formed laterally thereupon in transversely spaced opposition to that of the first key 48. A transverse direction x is illustrated in FIG. 2. The second key 50 is retained relative to the lower housing portion 34 by an elongate retainer gib 52 which is secured to the lower housing portion 34 by a series of fasteners 54.

The guide 41 of the lower housing portion 34 further comprises a pair of longitudinal rails 56, 56′ provided within the lower housing portion 34 and extending upward therefrom. A pair of keyways 58, 58′ are formed longitudinally through the carriage 40. The keyways 58, 58′ are sized to receive the rails 56, 56′, respectively. The cooperation of the rails 56, 56′ and keyways 58, 58′ provides transverse guidance and support to the carriage 40 as it translates along the guide 41. The carriage 40 includes a plurality of roller bearings 60, which are each pivotally connected to the carriage 48 and are offset from the keyways 58, 58′ and adjacent thereto for engaging a bearing surface provide upon each rail 56, 56′. As the carriage 40 translates along the guide 41, the carriage 40 is bearingly supported by the roller bearings 60 as they engage the surfaces provided by the rails 56, 56′.

The lower housing portion 34 includes a series of ribs 62 formed therein for providing cross support to the lower housing portion 34 and the gibs 42, 44, 46, 52. Accordingly, the two piece housing 32, 34 provides both a housing and a structural frame for the massage assembly 38. Both housing portions 32, 34 are each formed from an injection molding process or the like to provide low weight, yet rigid structural members. Additionally, the upper gib 42, central gib 44, lower gib 46 and rails 56, 56′ are integrally formed with the lower housing portion 34 thereby enhancing rigidity and structural cooperation therebetween and minimizing costs in components and assembly.

The upper housing portion 32 has a peripheral contour that exceeds the overall dimensions of the lower housing portion 34. This feature is to provide broad lateral support to the user that is distributed directly to the lower housing portion 34. A pair of lateral cushions 64, 64′ are each adhered to lateral undersides of the upper housing portion 32 to provide an overall thickness of the two piece housing that is generally uniform. Additionally, another cushion (not shown) is provided within the cover 16 and attached therein. The cushion is oriented to engage the top side of the upper housing portion 32 about its periphery for providing padded comfort and support to the user as the user rests its back against the backrest surface 24. The cushion is provided within the cover 16 rather than being adhered atop the upper housing portion 32 to permit access to the fasteners 36 that fasten the housing portions 32, 34 together.

The massage assembly 38 includes a motor 66, which is mounted to the carriage 40 and retained by a cover plate 68. The cover plate 68 and the carriage 40 collectively define a motor mount for the motor 66 and are fastened together by a plurality of fasteners 70. The motor 66 is operable to impart a massage effect from the massage assembly 38 and translate the carriage 40 along the guide 41 of the lower housing portion 34. The motor 66 includes a motor output shaft 72 extending from the motor 66 and driven thereby. A worm 74 is provided on the motor output shaft 72 and fixed relative to the shaft by a fastener 76. The worm 74 drives a pair of worm gears 78, 78′ in opposed rotational directions. Each worm gear 78, 78′ is secured to a gear shaft 80, 80′ by a fastener 82, 82′. The gear shafts 80, 80′ are each rotatably connected to the carriage 40 and the cover plate 68 so that the worm 74 drives the worm gear 78, 78′ in opposite rotary directions relative one another in a reduced rotation from that of the motor 66. The gear shafts 80, 80′ extend in direction z, which is perpendicular to both the longitudinal direction y and the transverse direction x.

Each gear shaft 80, 80′ extends through the cover plate 68 and receives a massage bracket 84, 84′, which are each fastened to the respective gear shaft 80, 80′ by a fastener 86, 86′. The massage brackets 84, 84′ are transversely spaced about the longitudinal axis y_{L}. Each massage bracket 84, 84′ includes a first massage hemispherical node 88, 88′ and a second hemispherical massage node 90, 90′ mounted to the respective bracket.

The gear shafts 80, 80′ are oriented perpendicular to the guide 41 and extend in the z direction towards the backrest surface 24. The massage nodes 88, 88′, 90, 90′ each rotate relative to the respective massage bracket 84, 84′ about an axis that is offset from that of the respective gear shaft 80, 80′. The massage nodes 88, 88′, 90, 90′ extend through a corresponding aperture 92, 92′ formed through the housing upper portion 32 for imparting the massage effect to the user through the cover 16. As the massage nodes 88, 88′, 90, 90′ revolve around the corresponding gear shaft 80, 80′ a rotary kneading massage effect is imparted upon the user, which is commonly referred to as a Shiatsu massage.

Each massage node 88, 88′, 90, 90′ is rotatably connected to the corresponding massage bracket 84, 84′ to reduce friction generated in the rotary kneading massage effect. Further, each massage node 88, 88′, 90, 90′ is axially translatable relative to the corresponding massage bracket 84, 84′ and is urged to an extended position in the z direction by a spring 93 (FIG. 2) retained between the corresponding massage node 88, 88′, 90, 90′ and the respective massage bracket 84, 84′. The springs 93 (FIG. 2) cause the massage nodes 88, 88′, 90, 90′ to extend and engage the user, yet permit the respective massage node 88, 88′, 90, 90′ to be urged to a retracted position upon a load provided by the user resting thereagainst thereby enhancing the kneading massage effect by adding axial compliancy to the operation of the rotary massage effect.

Additionally, the first massage nodes 88, 88′ have an overall height in the z direction greater than that of the second massage nodes 90, 90′ to extend further from the corresponding massage brackets 84, 84′. The first massage nodes 88, 88′ also have a diameter greater than that of the second massage nodes 90, 90′. These variations are utilized for varying the engagement of the rotary kneading effect with the user, resulting in a kneading effect that is nonsymmetrical and similar to a massage provided by the hands of a skilled massage therapist.

The apertures 92, 92′ formed through the upper housing portion 32 are generally elongate for permitting the massage nodes 88, 88′, 90, 90′ to pass therethrough as the carriage 40 is translated relative to the guide 41. Further, the cover plate 68 includes a roller bearing 94 pivotally connected thereto for engaging an underside bearing surface formed within the upper housing portion 32, thus providing bearing support between the carriage 40 and the upper housing portion 32. Accordingly, loading imparted upon the backrest surface 24 is translated through the upper housing portion 32 to the carriage 40 through roller bearing 94, to the lower housing portion 34 through the roller bearings 60 for providing bearing support therebetween and preventing such loading from inhibiting the translation of the carriage 40 along the guide 41.

A first pinion gear 96 is mounted upon gear shaft 80′ between the worm gear 78′ and the carriage 40 for being driven by rotation imparted upon the worm gear 78′. A first reduction gear 98 is rotatably mounted upon an intermediate shaft 100 that is supported by the carriage 40 for rotation about an axis in the z direction. A second pinion gear 102 is secured to the first reduction gear 98 and driven by the rotation imparted upon the first reduction gear 98. The second pinion gear 102 is engaged with a second reduction gear 104. The second reduction gear 104 is rotatably coupled to the carriage 40 about a shaft 106, which is supported between the carriage 40 and the cover plate 68 for rotation about an axis in the z direction. A third pinion gear 108 is secured to the second reduction gear 104 and oriented about the shaft 106 between the second reduction gear 104 and the carriage 40. The third pinion gear 108 is engaged to a gear rack 110 formed along the retainer gib 52.

The worm 74, worm gear 78′, first pinion gear 96, first reduction gear 98, second pinion gear 102, second reduction gear 104, third pinion gear 108 and gear rack 110 provide a transmission such that rotation from the motor output shaft 72 experiences three stages of reduction for reduced rotation of the third pinion gear 108 relative to the motor output shaft 72 and two stages of reduction relative to the massage nodes 88, 88′, 90, 90′. Since the rack 110 is fixed relative to the guide 41, rotation of the third pinion 108 translates the carriage 40 along the guide 41. Accordingly, the rotation of the motor output shaft 72 results in both a rotary kneading massage effect and translation of the carriage along the guide due to the engagement with the gear rack 110.

Due to the translation of the carriage 40 and the motor 66, cord management is necessary to ensure that a power cord 112, which provides power to the motor 66 does not interfere with, nor get damaged by the operations of the massage assembly 38. Accordingly, a longitudinal bar 114 is provided within the backrest region 12 mounted to the lower housing portion 34. The power cord 112 is coiled about the bar 114 for extension and retraction thereabout as the carriage 40 is translated along the guide 41.

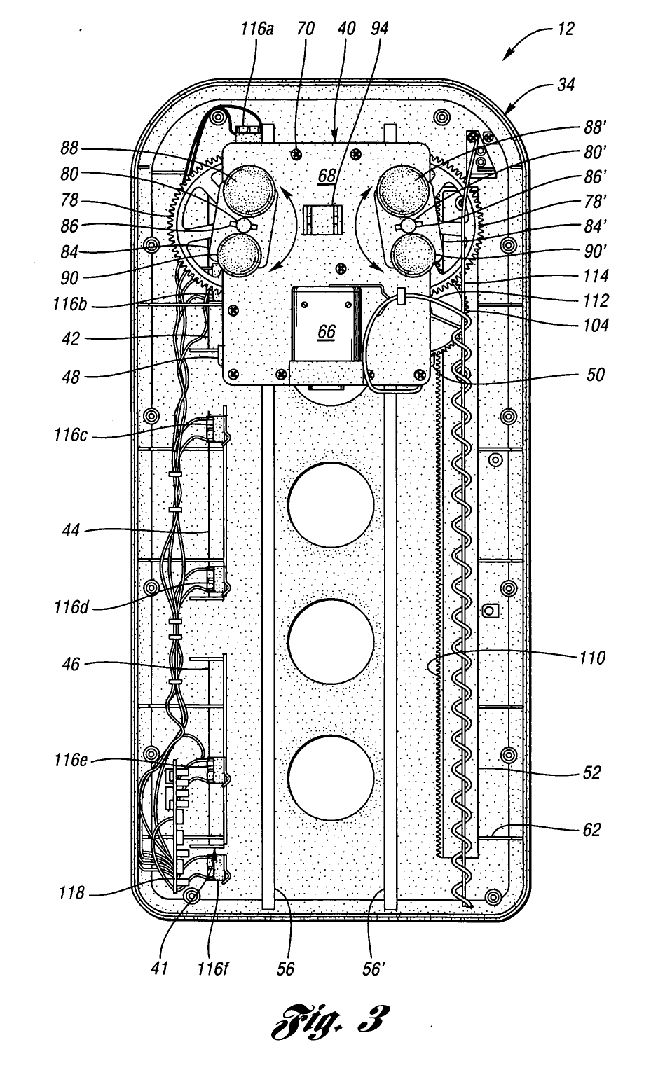

The motor 66 is directly coupled to the associated transmission for translation of the carriage 40 when the motor 66 is powered. In order to reverse direction of the carriage 40, the rotational direction of the motor 66 is reversed as well. In order to control the reversal of power to the motor 66, a series of limit switches 116a-116f are provided along the guide 41. Each limit switch 116a-116f includes a leaf spring which extends in an unloaded position thereof. Upon actuation of each leaf spring, the respective limit switch 116a-116f sends a signal indicating the actuation. Accordingly, the limit switches 116a-116f are each oriented so that the associated leaf spring extends into the path of travel of the carriage 40 for actuation thereby. The signals provided by the limit switches 116a-116f are processed by a central processing unit provided at a circuit board 118, mounted within the backrest region 12 to the lower housing portion 34 as illustrated in FIG. 3.

The user operates the remote 28 to select a desired target range of massage to be imparted to the user's back. The range selected on the remote 28 is processed so that a pair of limit switches 116a-116f provide the range of travel of the carriage 40. For example, if the user selects a range of massage associated with the entire back, the limit switches 116a-116f control this operation. For example, referring to FIG. 3, with the carriage 40 in a position which actuates the limit switch 116a, the motor 66 begins a rotation which provides a rotary kneading massage effect rotating the massage nodes 88, 88′, 90, 90′ and translates the carriage 40 along the guide 41 towards the limit switch 116f. Upon the carriage 40 actuating the limit switch 116f, a signal is sent to the central processing unit, which consequently reverses the rotation of the motor 66. The reversed rotation of the motor 66 provides a reversed rotation of the rotary kneading massage and translates the carriage 40 towards the limit switch 116a.

Various ranges of massages are provided by the series of limit switches 116a-116f so that the user may target desired regions of massage upon the back of the user.

In order to simplify the manufacture of the backrest region 12, the limit switches 116a-116f are each adhered to the housing lower region 34 by resistance welding, friction welding, adhesives or the like.

Briefly, the kneading massage effect is generated from the simplified massage assembly 38 and corresponding support frame and guide 41. Accordingly, the kneading massage effect is provided within the body massager 10 without limiting the portability and weight of the massager 10. Additionally, the motor 66 is provided upon the carriage 40 to overcome shortcomings of prior art kneading massagers that require either two motors to provide both a massage effect and translation of the massage effect or a complex drive system for providing both effects, which commonly requires a heavy duty frame for supporting the complex drive system.

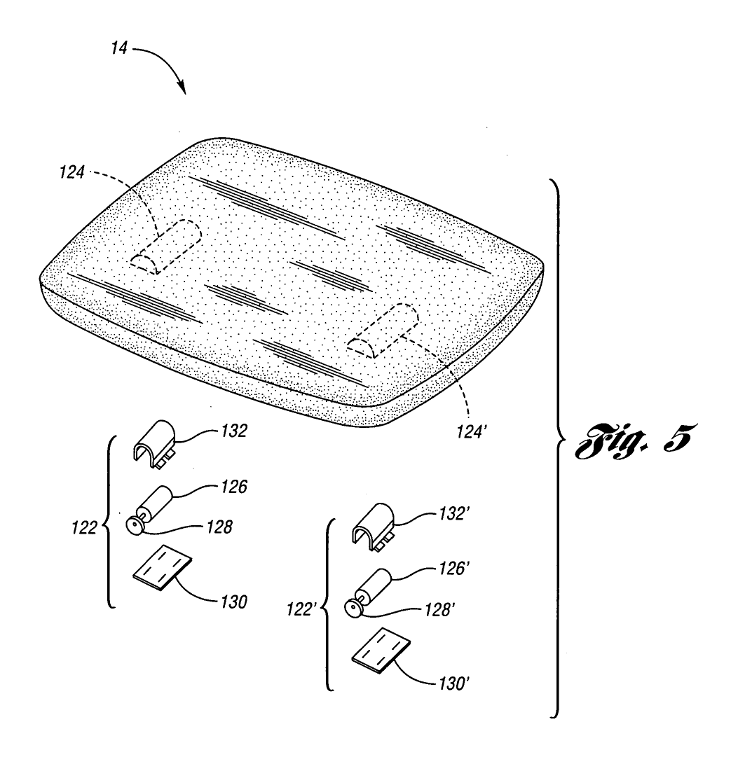

Referring now to FIG. 5, the seat support region 14 is illustrated without the cover 16 and is partially exploded. The seat support region 14 comprises a seat support housing defined by a unitary cushion 120 for providing comfort and resilient support to the user. The cushion 120 includes a pair of vibratory massage assemblies 122, 122′ housed therein. The cushion 120 has a pair of recesses 124, 124′ formed in its underside illustrated in hidden for receiving each of the respective vibratory massage assemblies 122, 122′. Each vibratory massage assembly 122, 122′ includes a motor 126, 126′ for imparting rotary motion to an eccentric weight 128, 128′ for generating an invigorating vibratory massage effect upon the cushion 120, which is received by the user seated thereupon. The vibratory massage assemblies 122, 122′ are spaced transversely apart relative one another to distribute the massage effect upon the cushion 120.

Each vibratory massage assembly 122, 122′ includes a bracket 130, 130′ for securing the respective assembly to the underside of the cushion. Specifically, each bracket 130, 130′ may be adhered to the underside of the cushion 120 by an adhesive. Each vibratory massage assembly 122, 122′ includes a motor mount bracket 132, 132′ for securing the respective motor 126, 126′ to the corresponding bracket 130, 130′.

The operation of the vibratory massage assemblies 122, 122′ is controlled by the remote 28. Therefore, the vibratory massage effect may be imparted to the user alone or in combination with the rotary kneading massage effect. By way of example, the operation of the vibratory massage assemblies 122, 122′ includes a steady massage, wherein both vibratory massage assemblies 122, 122′ provide a consistent vibratory massage effect to the user. Additionally, a tapping massage effect is provided wherein both vibratory massage assemblies are operated synchronously with a common direction of rotation relative to another so that the user experiences a vibratory massage effect that is generally enhanced rather than merely vibrating. Additionally, a side to side vibratory massage effect is provided wherein each vibratory massage assembly 122, 122′ cycles alternatingly so that the user experiences a vibratory massage effect that is directed from one of the vibratory massage assemblies 122 to the other 122′. The remote 28 provides control of the intensity of the vibratory massage effect such as low, medium and high wherein the intensity is a result of the speed of the motors 126, 126′.

In summary, the body massager 10 provides an efficient, portable, lightweight, sturdy massage apparatus which generates two types of massage to two areas of the body with operational variations thereof so that the user may experience a variety of massage effects or a desired targeted massage effect, while minimizing the costs of the overall massager.

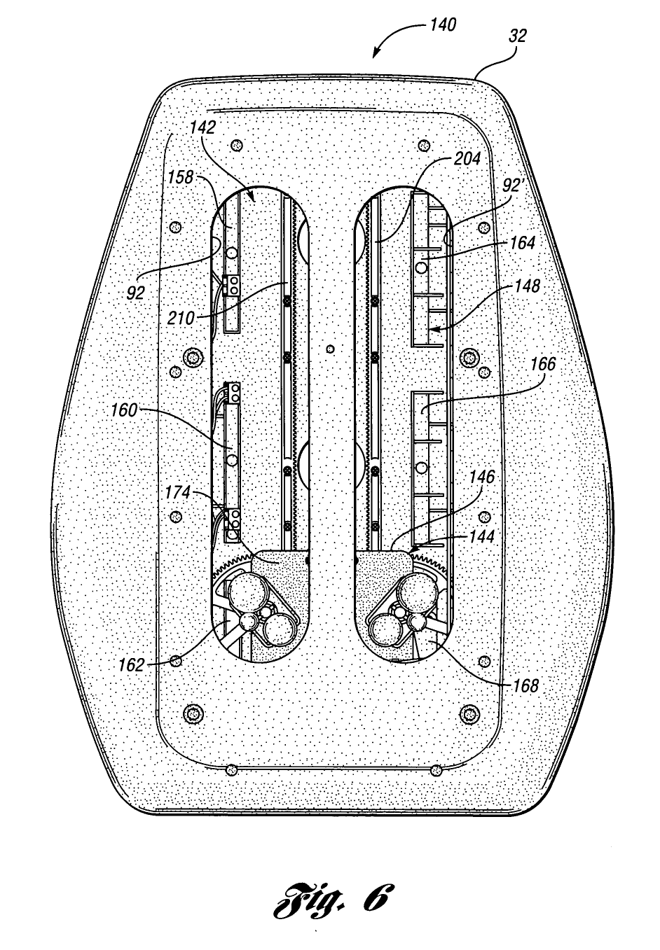

Referring now to FIG. 6, another embodiment backrest region is illustrated in accordance with the present invention and is referenced generally by numeral 140. The backrest region 140 is illustrated without a cover, such as the cover 16 (FIG. 1), which is removed for revealing components of the backrest region 140. The backrest region 140 may be utilized as a seatback cushion and massager, or may include a seat support region, such as seat support region 14 (FIG. 1), for a seat support cushion and/or a massager.

As depicted in FIG. 6, the backrest region 140 includes an upper housing portion 32 and a lower housing portion 142. The upper housing portion 32 includes a pair of apertures 92, 92′ so that a massage effect may be imparted by a massage assembly 144 through the upper housing portion 32 to a body part of the user.

With reference to FIGS. 6-8, the massage assembly 144 includes a carriage 146 mounted to a longitudinal guide 148 of the lower housing portion 142 for limited longitudinal translation of the carriage 146 along the guide 148. Similar to the prior embodiment, the massage assembly 144 includes a pair of transversely spaced apart massage brackets 150, 150′, each rotatably connected to the carriage 146. Each massage bracket 150, 150′ is provided with a first massage node 152, 152′, a second massage node 154, 154′, and a third massage node 156, 156′ rotatably connected to the respective massage bracket 150, 150′. The apertures 92, 92′ in the upper housing portion 32 permit the massage nodes 152, 152′, 154, 154′, 156, 156′ to extend from the carriage 146 for engagement with the user.

The massage brackets 150, 150′ are rotated relative to the carriage 146 such that the massage nodes 152, 152′, 154, 154′, 156, 156′ provide a rotary kneading massage effect to the user. Additionally, the massage nodes 152, 152′, 154, 154′, 156, 156′ of each massage bracket 150, 150′ vary in height and diameter for providing a massage effect that varies in contact and engagement to replicate a manual kneading massage effect from a skilled massage therapist. Additionally, the larger massage nodes, namely the first and second massage nodes 152, 152′, 154, 154′, of each massage bracket 150, 150′ are axially translatable and are provided with springs, such as springs 93 (FIG. 2), for providing axial compliancy to the massage nodes 152, 152′, 154, 154′ and the associated massage effect. The third massage nodes 156, 156′ may provide an ancillary massage effect, such as heat, or any other suitable ancillary effect, as is known in the art.

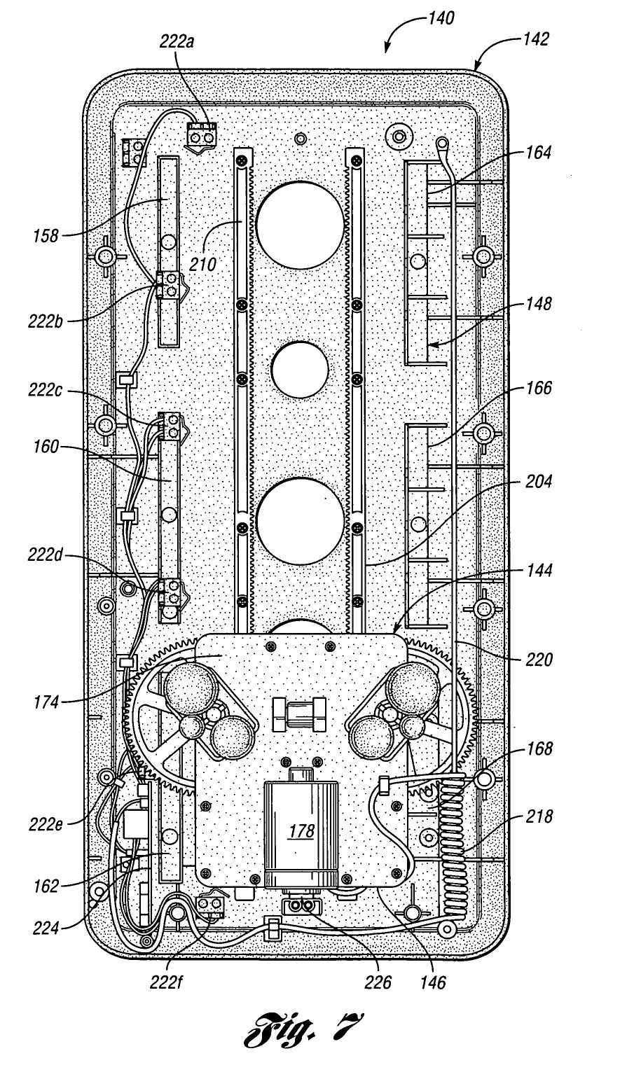

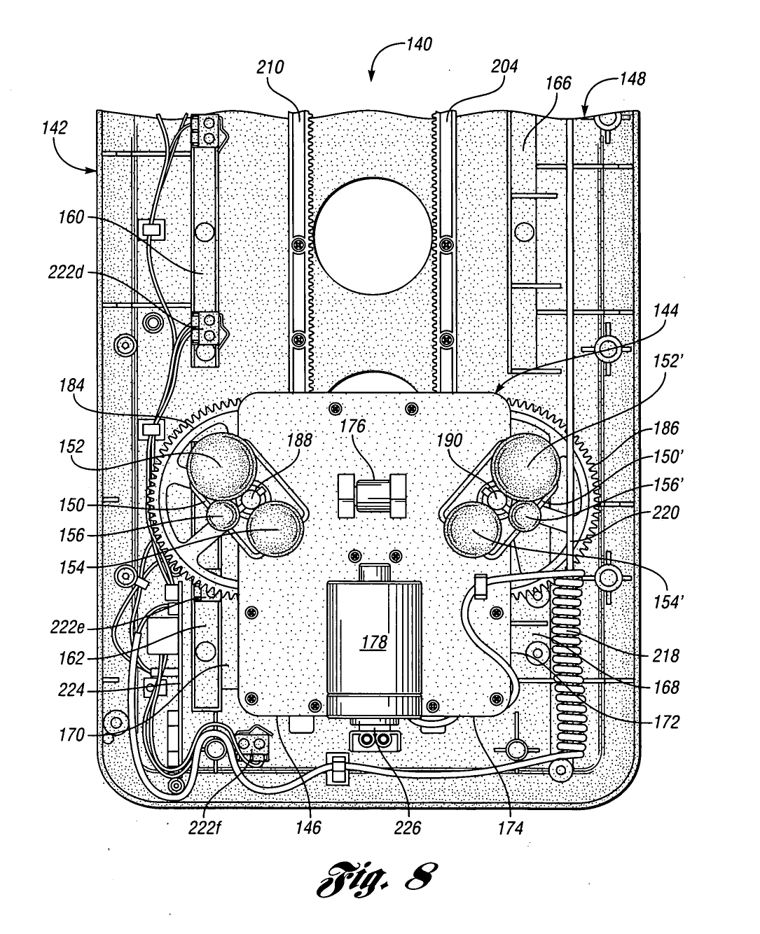

The guide 148 includes a series of gibs which are referenced and indicated in FIG. 7 as a left upper gib 158, a left central gib 160, a left lower gib 162, a right upper gib 164, a right central gib 166 and a right lower gib 168. Referring now to FIG. 8, the carriage 146 includes an opposed pair of keys 170, 172 extending laterally outboard from the carriage 146 and retained below the gibs 158, 160, 162, 164, 166, 168 for retaining the carriage 146 within the lower housing portion 142 as the carriage 146 translates. The left upper gib 158, left central gib 160, left lower gib 162, right upper gib 164, and right central gib 166 are formed integrally with the lower housing portion 142, for example by an injection molding process of a polymeric material. The right lower gib 168 is formed separately to permit the insertion of the keys 170, 172 into the gibs 158, 160, 162, 164, 166 during assembly. Subsequently, the right lower gib 168 is fastened to the lower housing portion 142.

The carriage 146 includes a cover plate 174. A roller bearing 176 is mounted for rotation to the cover plate 174. The roller bearing 176 engages an underside of the upper housing portion 32 so that loads, such as the weight of a body part, that are applied to the upper housing portion 32 are distributed to the carriage 146 through the roller bearing 176 to reduce friction between the carriage 146 and the upper housing portion 32. The cover plate 174 also provides a part of a motor mount for a motor 178 that is retained within the carriage 146.

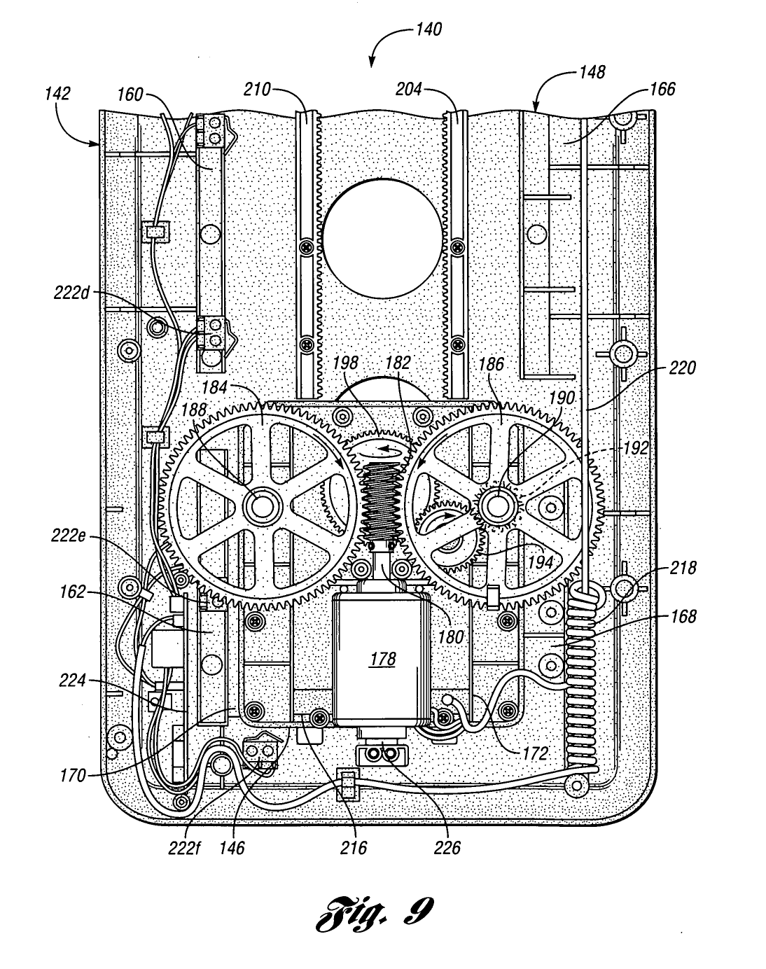

FIG. 9 illustrates the carriage 146 with the cover plate 174 removed. The motor 178 includes a motor output shaft 180 that is driven for rotation by the motor 178. A worm 182 is mounted to the motor output shaft 180 and extends between and into engagement with a pair of transversely spaced worm gears 184, 186. Each worm gear 184, 186 is mounted to a gear shaft 188, 190, which are each rotatably mounted in the carriage 146. The gear shafts 188, 190 each extend through the cover plate 174. The massage brackets 150, 150′ are each mounted to a distal end of one of the gear shafts 188, 190 external of the cover plate 174. Thus, when the motor 178 drives the motor output shaft 180, the worm 182 drives the worm gears 184, 186 for driving the gear shafts 188, 190 and consequently driving the massage brackets 150, 150′ and the corresponding massage nodes 152, 152′, 154, 154′, 156, 156′, for generating a rotary kneading massage effect. Since the worm 182 drives both worm gears 184, 186, the left worm gear 184 is driven in reverse rotation than that of the right worm gear 186 for providing a uniform rotary massage effect.

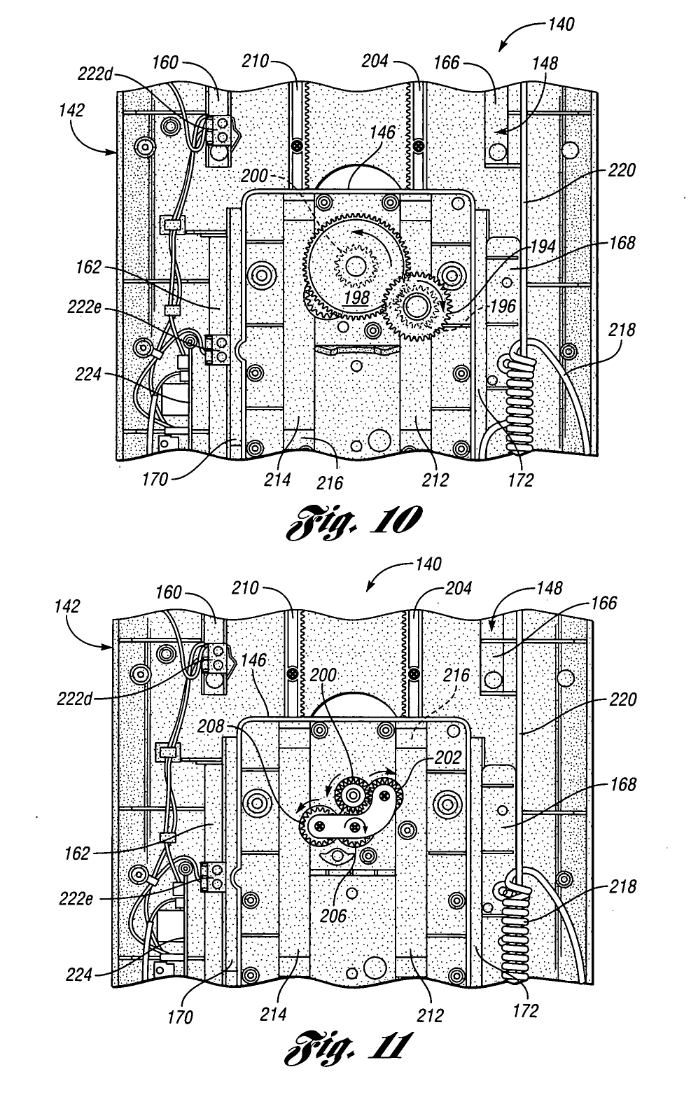

The motor 178 also drives the carriage 146 along the guide 148. A first spur gear 192, shown hidden in FIG. 9, is mounted to the right gear shaft 190 beneath the right worm gear 186 and the first spur gear 192 is consequently driven for rotation with the right worm gear 186. A first reduction gear 194 is mounted for rotation in the carriage 146 and engaged with the first spur gear 192 for being driven in a reduced rotation. Referring now to FIG. 10, a second spur gear 196, illustrated in hidden, is mounted to the first reduction gear 194, beneath the first reduction gear 194 for rotation with the first reduction gear 194. A second reduction gear 198 is also mounted for rotation in the carriage 146, and is engaged with the second spur gear 196 for being driven in a reduced rotation by the second spur gear 196.

With reference now to FIG. 11, a third spur gear 200 is illustrated that is mounted for rotation in the carriage 146. The third spur gear 200 is coupled to the second reduction gear 198 and rotates with the second reduction gear 198. The third spur gear 200 is engaged with a first pinion gear 202 that is also mounted for rotation in the carriage 146. The first pinion gear 202 engages a longitudinal gear rack 204 that is secured within the lower housing portion 142. The third spur gear 200 drives a fourth spur gear 206 that is mounted for rotation in the carriage 146. The fourth spur gear 206 drives a second pinion gear 208 that is mounted for rotation in the carriage 146. The second pinion gear 208 engages a second longitudinal gear rack 210 that is fastened to the lower housing portion 142. The rotation of the pinion gears 202, 208 causes the carriage 146 to translate along the guide 148.

Referring again to FIG. 9, the operation of the transmission of the massage assembly 144 is illustrated beginning with the motor 178. As the motor 178 drives the motor output shaft 180 and worm 182 in a counter-clockwise direction when viewed axially and referenced by the arcuate arrow, the left worm gear 184 rotates clockwise; and the right worm gear 186 and the first spur gear 192 rotate counter-clockwise. The first spur gear 192 therefore drives the first reduction gear 194 in a clockwise direction.

FIG. 10 illustrates the first reduction gear 194 and the second spur gear 196 rotating clockwise, thereby driving the second reduction gear 198 counter-clockwise. The third spur gear 200 rotates counter-clockwise with the second reduction gear 198. In FIG. 11, the third spur gear 200 drives the first pinion gear 202 clockwise in engagement with the first rack 204 to drive the carriage 146 in an upward direction in FIG. 11. The fourth spur gear 206 is utilized between the third spur gear 200 and the second pinion gear 208, so that the fourth spur gear 206 rotates clockwise and therefore the second pinion gear 208 rotates counter-clockwise, which is the opposite direction of the first pinion gear 202, thereby also driving the carriage 146 upward due to the engagement with the second rack 210. Thus the fourth spur gear 206 is sized so that the second pinion gear 208 rotates at the same rate as the first pinion gear 202.

Moreover, the transmission of the massage assembly 144 provides a reduced rotation from the motor 178 to the massage brackets 150, 150′, and an even further reduced rotation from the motor 178 to the pinion gears 202, 208 so that a rotary kneading massage is imparted upon the user as the carriage 146 translates along the guide 148. A reversed rotation of the motor results in a reversed rotary kneading massage effect and a reversed translation of the carriage 146 due to a reversal of the massage components, which is opposite of the rotary directions depicted in FIGS. 9-11.

By utilizing a pair of gear racks 204, 210, even loading of the carriage 146 is applied thereby providing a stabilized translation of the carriage 146. Thus, the driving torque for translating the carriage 146 is distributed through the spaced pair of pinion gears 202, 208 for evenly actuated translation of the carriage 146.

The carriage 146 has a transverse pair of keyways 212, 214 formed through the carriage 146. Each of the keyways 212, 214 is aligned with one of the gear racks 204, 210 so that the gear racks 204, 210 also provide lateral guide support to the carriage 146. Thus, separate rails are eliminated by the use of gear racks 204, 210 for lateral support. The pinion gears 202, 208 intersect the keyways 212, 214 for access to the gear racks 204, 210. Additionally, a pair of roller bearings 216 are displaced within each keyway 212, 214 to engage a forward bearing surface of each gear rack 204, 210. Thus, loading imparted to the carriage 146, such as a reaction force during the massage operation, or the weight from the body portion of the user, is distributed from the carriage 146 to the lower housing portion 142 through the roller bearings 216. Further, friction is reduced between the carriage 146 and the lower housing portion 142 by the roller bearings 216.

Similar to the prior embodiment, a coiled power cord 218 is provided in the backrest region 140 as illustrated in FIG. 7. The power cord 218 powers the motor 178. A longitudinal bar 220 is mounted within the lower housing portion 142 for extension and retraction of the coiled power cord 218 along the bar 220.

The backrest region 140 also includes a series of limit switches 222a-222f for providing signals for indicating the orientation of the carriage 146. The signals are processed by a controller of a circuit board 224 within the backrest region 140 and/or a circuit board in the associated remote 28 (FIG. 1). As discussed above with reference to the prior embodiment, the signals from the limit switches 222a-222f are utilized to reverse the direction of the motor 178 and consequently reverse the direction of the carriage 146. The limit switches 222a-222f provide various ranges of massage so that the user can select a desired target range, such as upper back, mid back, lower back, or combinations of these regions, including entire length of the back.

The controller may also cooperate with the massage assembly 144 to return the carriage 146 to a parked position when not in use. For example, upon the user selecting the termination of a massage operation through the remote 28, the controller may drive the motor 178 in a direction for translating the carriage 146 to a lowermost position in the backrest region 140, which is indicated by the lowermost limit switch 222f. Thus, the carriage 146 may rest against a bumper 226 when not in operation so that the load of the carriage 146 is supported upon the bumper 226 instead of being supported by the transmission of the carriage 146. This parked position may also serve as a start position for massage programs such that the programs of the controller may have a consistent start position for various massage programs.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed:

1. A body massager comprising:
a longitudinal housing having an external contact surface for receiving a portion of a body of a user;
a longitudinal guide mounted in the housing;
a carriage oriented in the housing and cooperating with the guide for limited longitudinal translation in the housing along the guide;
a motor supported upon the carriage, the motor having a motor output shaft driven thereby, the motor output shaft being operably coupled to the housing to translate the carriage along the guide; and
at least a pair of transversely spaced massage members, each being supported by the carriage for rotation about an axis, the massage member axes being transversely spaced apart for providing a kneading massage effect.

2. The body massager of claim 1 wherein the axis of rotation of each of the at least a pair of massage members is generally perpendicular to the housing contact surface.

3. The body massager of claim 1 wherein the housing has a longitudinal axis and the axis of rotation of each of the at least a pair of massage members is generally perpendicular to both the longitudinal axis of the housing and a transverse axis of the housing.

4. The body massager of claim 1 wherein the at least a pair of massage members are each operably driven by the motor output shaft for rotation relative to the carriage to impart a rotary kneading massage effect to the user.

5. The body massager of claim 1 wherein each of the at least a pair of massage members further comprises at least three massage nodes that are not coaxial with the axis of rotation of the corresponding massage member.

6. The body massager of claim 5 wherein the at least three massage nodes of each of the at least a pair of massage members, extend from the carriage at varying distances.

7. The body massager of claim 5 wherein at least two of the at least three massage nodes of the at least a pair of massage members, are axially translatable relative to the carriage between an extended position and a retracted position.

8. The body massager of claim 7 wherein each of the at least two axially translatable massage nodes of each of the at least a pair of massage members further comprise a spring for biasing the at least two axially translatable massage nodes towards the extended position.

9. A body massager comprising:
a housing:
a carriage oriented within the housing for linear translation within the housing;
a motor mounted to the carriage and operably connected to the housing for translating the carriage within the housing; and
a pair of transversely spaced massage members mounted to the carriage for extending from the housing, the massage members being operably driven by the motor for imparting a kneading massage effect to a user as the massage members and carriage translate relative to the housing.

10. A portable body massager sized to be received and supported by a conventional chair, the massager comprising:
a portable housing sized to be received and supported by a backrest of the conventional chair, the housing having a longitudinal axis and an external contact surface for receiving a portion of a body of a user;
a longitudinal guide mounted in the housing;
a carriage oriented in the housing and cooperating with the guide for limited longitudinal translation in the housing along the guide;
a motor supported upon the carriage, the motor having a motor output shaft driven thereby, the motor output shaft being operably coupled to the housing to translate the carriage along the guide;
at least a pair of massage members transversely spaced about the longitudinal axis, each of the at least a pair of massage members being supported by the carriage for rotation relative to the carriage, the at least a pair of massage members extending out of the housing through an aperture formed through the body contacting surface for imparting a massage effect upon the portion of the user's body as the carriage is translated relative to the housing;
a gear mounted to and driven by the motor output shaft;
at least a pair of pinion gears rotatably mounted to the carriage and operably driven by the output gear; and
a pair of longitudinal gear racks affixed to the housing, each engaged with one of the at least a pair of pinion gears such that rotation of the at least a pair of pinion gears translates the carriage along the guide.

11. The body massager of claim 10 further comprising a pair of rollers rotatably connected to the carriage, each in operable engagement with a bearing surface of one of the pair of gear racks for providing bearing support to the carriage.

12. The body massager of claim 10 wherein the carriage includes a pair of longitudinal keyways formed therethrough with one of the pair of gear racks disposed through each keyway for providing lateral support to the carriage.

13. The body massager of claim 10 further comprising:
at least a pair of limit switches oriented within the housing to be actuated by the carriage at positions along the guide for providing a signal indicative of carriage orientation; and
a controller in communication with the at least a pair of limit switches for reversing rotation of the motor in response to a signal from one of the at least a pair of limit switches for consequently reversing translation of the carriage along the guide, wherein the controller returns the carriage to a start position upon completion of a massage operation.

14. The body massager of claim 10 wherein each massage member is operably connected to and driven by the motor output shaft for providing a rotary massage effect to the user.

15. The body massager of claim 10 wherein the output gear further comprises a worm, and the body massager further comprises at least a pair of worm gears engaged to the worm.

16. The body massager of claim 15 wherein the at least a pair of worm gears are each coupled to one of the at least a pair of massage members for imparting rotation from the motor output shaft to the at least a pair of massage members.

17. The body massager of claim 15 wherein at least one of the at least a pair of worm gears operably drives the at least a pair of pinion gears.

18. The body massager of claim 15 further comprising a spur gear coupled to one of the at least a pair of worm gears for rotation therewith.

19. The body massager of claim 18 further comprising:
a first reduction gear engaged with and driven by the spur gear;
a second spur gear coupled to the first reduction gear for rotation with the first reduction gear;
a second reduction gear engaged with and driven by the second spur gear; and
a third spur gear coupled to the second reduction gear for rotation with the second reduction gear, wherein one of the at least a pair pinion gears is engaged to and driven by the third spur gear.

20. The body massager of claim 19 further comprising a fourth spur gear engaged to and driven by the third spur gear, wherein another of the at least a pair of pinion gears is engaged to and driven by the fourth spur gear.
